(19) United States
(12) Patent Application Publication
(10) Pub. No.: US 2025/0267717 A1
(43) Pub. Date: Aug. 21, 2025

(54) Methods And Apparatus For Initial Access With Enhanced Beam Configuration In Wireless Communications

(71) Applicant: MediaTek Inc., Hsinchu City (TW)

(72) Inventors: Gilles Charbit, Cambridge (GB); Abdelkader Medles, Cambridge (GB); Pradeep Jose, Cambridge (GB); Ogeen Hanna Toma Toma, Cambridge (GB); Waseem Hazim Ozan Ozan, Cambridge (GB)

(21) Appl. No.: 19/049,015

(22) Filed: Feb. 10, 2025

Related U.S. Application Data
(60) Provisional application No. 63/554,250, filed on Feb. 16, 2024.

(51) Int. Cl. H04W 74/0833; H04W 52/02; H04W 84/06

(52) U.S. Cl. CPC H04W 74/0833; H04W 52/0203; H04W 84/06

(57) ABSTRACT

Various solutions for initial access with enhanced beam configuration in wireless communications are described. A network node may configure a cell with at least one wide beam and one or more narrow beams. The wide beam is associated with a cell-defining synchronization signal block (CD-SSB) and each of the narrow beams is associated with a non-cell-defining synchronization signal block (NCD-SSB) or a channel state information-reference signal (CSI-RS). The network node may transmit the CD-SSB on the wide beam. Then, the network node may receive a random access request from an apparatus for initial access to the cell.

### CROSS REFERENCE TO RELATED PATENT APPLICATION(S)

The present disclosure is part of a non-provisional application claiming the priority benefit of U.S. Patent Application No. 63/554,250, filed 16 Feb. 2024, the content of which herein being incorporated by reference in its entirety.

### TECHNICAL FIELD

The present disclosure is generally related to wireless communications and, more particularly, to initial access with enhanced beam configuration in wireless communications.

### BACKGROUND

Unless otherwise indicated herein, approaches described in this section are not prior art to the claims listed below and are not admitted as prior art by inclusion in this section.

In 3^{rd} generation partnership project (3GPP) Release 17, non-terrestrial network (NTN) is introduced as a terminal-satellite direct communication technology based on the new radio (NR) interface. With the integration of satellite network and ground cellular network (e.g., 5^{th} generation (5G) network), NTN may provide ubiquitous coverage without being restricted by terrain and landform. As NTN continues to evolve in the 5G-Advanced stage, it has become an important part of 3GPP Release 18 work plan. Currently, NTN may include two workgroups: Internet-of-Things (IoT) NTN and New Radio (NR) NTN. IoT NTN focuses on satellite IoT services that support low-complexity enhanced machine-type communication (eMTC) and narrowband Internet-of-things (NB-IoT) user equipment (UE). NR NTN uses the 5G NR framework to enable direct connection between satellites and smartphones to provide voice and data services.

Typically, the total satellite transmission power for downlink (DL) transmission on the service link is split equally between multiple beams that are simultaneously active. However, this will result in lower transmission power per active beam. FIG. 1 illustrates an example scenario 100 of satellite beam configuration under current NTN framework. As shown in FIG. 1, the satellite is configured with K_{active}=8 active beams, including 1 wide beam (or called coarse beam) and 7 narrow beams (or called fine beams). Assuming the total transmission power of the satellite as Sₜₒₜₐₗ, the transmission power available for each active beam would be Sₜₒₜₐₗ/N_{active}, resulting in a non-ideal signal-to-noise ratio (SNR) loss per beam of Loss=10*LOG10(K_{active})=9 decibel (dB). Furthermore, under current NTN framework as specified in 3GPP, it is assumed that the beams are always ON (i.e., activated), which would be detrimental to power conservation.

Accordingly, how to enhance satellite beam configuration and adapt initial (cell) access procedure to support enhanced satellite beam configuration becomes an important issue for modern wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to initial access with enhanced beam configuration in wireless communications. It is believed that the above-described issue would be avoided or otherwise alleviated by implementing one or more of the proposed schemes described herein.

In one aspect, a method may involve a network node configuring a cell with at least one wide beam and one or more narrow beams, wherein the wide beam is associated with a cell-defining synchronization signal block (CD-SSB) and each of the narrow beams is associated with a non-cell-defining synchronization signal block (NCD-SSB) or a channel state information-reference signal (CSI-RS). The method may also involve the network node transmitting the CD-SSB on the wide beam. The method may further involve the network node receiving a random access request from an apparatus for initial access to the cell.

In one aspect, a method may involve an apparatus receiving a CD-SSB of a cell from a network node, wherein the cell is configured with at least one wide beam associated with the CD-SSB and one or more narrow beams each associated with an NCD-SSB or a CSI-RS. The method may also involve the apparatus performing DL synchronization to the cell based on the CD-SSB. The method may further involve the apparatus transmitting a random access request to the network node on the wide beam or one of the narrow beams for initial access to the cell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of satellite beam configuration under current NTN framework.

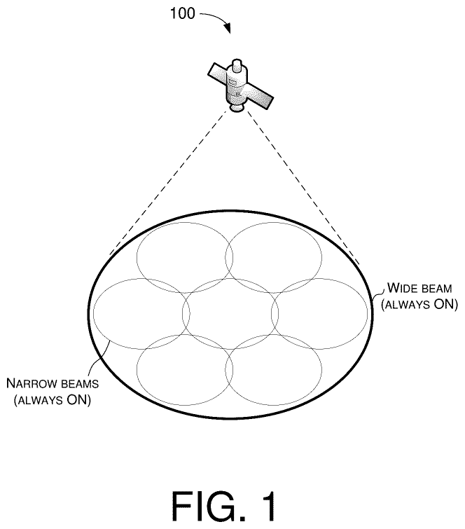

FIG. 2 is a diagram depicting an example scenario of a communication environment in which various solutions and schemes in accordance with the present disclosure may be implemented.

FIG. 3 is a diagram depicting an example scenario of enhanced satellite beam configurations in accordance with an implementation of the present disclosure.

FIG. 4 is a diagram depicting an example scenario of SSB transmission on wide beam(s) for initial access in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to initial access with enhanced beam configuration in wireless communications. According to the present disclosure, a number of possible solutions may be implemented separately or jointly. That is, although these possible solutions may be described below separately, two or more of these possible solutions may be implemented in one combination or another.

In the present disclosure, NTN refers to a network that uses radio frequency (RF) and information processing resources carried on high, medium and low orbit satellites or other high-altitude communication platforms to provide communication services for UEs. According to the load capacity on the satellite, there are two typical scenarios, namely: transparent payload and regenerative payload. In transparent payload mode, the satellite does not process the signal and waveform in the communication service but, rather, only functions as an RF amplifier to forward data. In regenerative payload mode, the satellite, other than RF amplification, also has the processing capabilities of modulation/demodulation, coding/decoding, switching, routing and so on.

Under current NTN framework, it is assumed that the beams are always ON (i.e., activated), which would be detrimental to power conservation. However, if the satellite beam configuration is to be relaxed to allow the satellite to switch beams ON or OFF (i.e., deactivated), initial (cell) access procedure will need to be adapted to ensure that the UE is able to complete initial access, cell re-selection, and/or idle-mode mobility as needed.

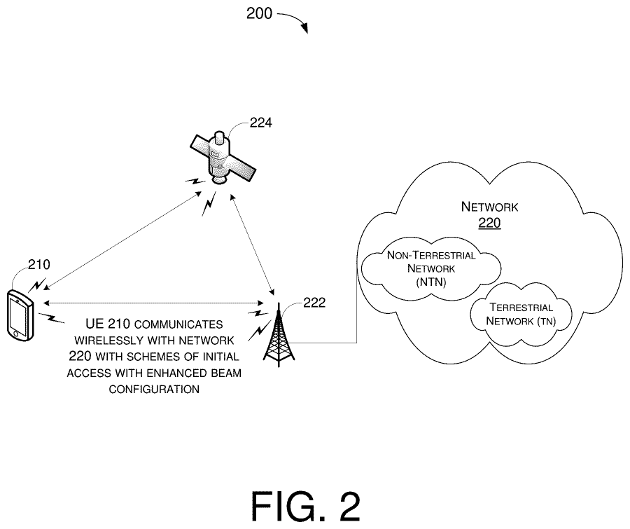

In view of the above, the present disclosure is motivated by, but not limited to, NTN scenarios, and accordingly proposes a number of schemes pertaining to initial access with enhanced beam configuration. FIG. 2 illustrates an example scenario 200 of a communication environment in which various solutions and schemes in accordance with the present disclosure may be implemented. Scenario 200 involves a UE 210 in wireless communication with a network 220 (e.g., a wireless network including an NTN and a TN) via a terrestrial network node 222 (e.g., a base station (BS) such as an evolved Node-B (eNB), a Next Generation Node-B (gNB), or a transmission/reception point (TRP)) and/or a non-terrestrial network node 224 (e.g., a satellite). For example, the terrestrial network node 222 and/or the non-terrestrial network node 224 may form an TN/NTN serving cell for wireless communication with the UE 210. In such communication environment, the UE 210, the network 220, the terrestrial network node 222, and the non-terrestrial network node 224 may implement various schemes pertaining to initial access with enhanced beam configuration in wireless communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

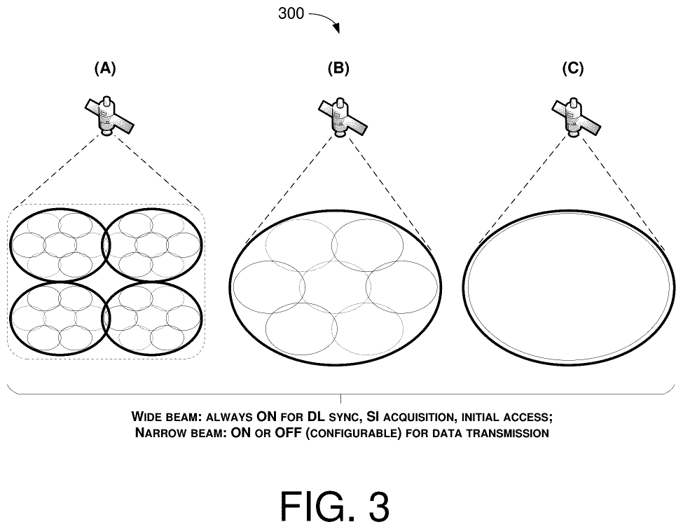

FIG. 3 illustrates an example scenario 300 of enhanced satellite beam configurations in accordance with an implementation of the present disclosure. Part (A) of FIG. 3 depicts a satellite forming a multiple-beam cell with 4 wide beams and 7 narrow beams within each wide beam. Part (B) of FIG. 3 depicts a satellite forming a multiple-beam cell with 1 wide beam and 7 narrow beams within the wide beam. Part (C) of FIG. 3 depicts a satellite forming a single-beam cell. In general, each wide beam and narrow beam covers a geographical area where one or more UEs may be located. For example, a wide beam may cover a relatively large area to serve UE(s) within that area for DL synchronization, system information (e.g., at least system information block type 1 (SIB1)) acquisition, and/or initial access. A narrow beam may cover a relatively small area to serve UE(s) within that area for data transmission. More specifically, the wide beam(s) may be configured to be always ON (denoted with solid line in FIG. 3) for DL synchronization, system information (SI) (at least SIB1) acquisition, and initial access, while the narrow beams may be configured to be ON or OFF (denoted with dotted line in FIG. 3) as required for data transmission.

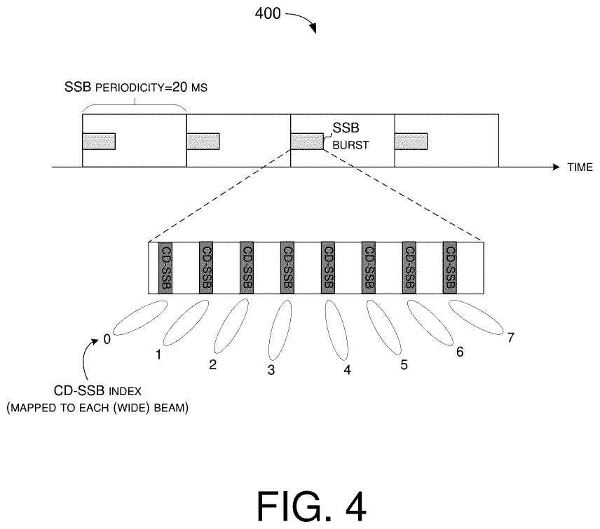

FIG. 4 illustrates an example scenario 400 of SSB transmission on wide beam(s) for initial access in accordance with an implementation of the present disclosure. Scenario 400 depicts the case of a satellite forming a multi-beam cell which is configured with one or more wide beams with initial bandwidth part #0 (BWP #0) or control resource set #0 (CORESET #0) for DL synchronization, SI acquisition, and initial access, and multiple narrow beams each associated with a BWP dedicated for data transmission. There is one physical cell identity (PCI) per wide beam in the satellite. As shown in FIG. 4, there are time domain multiplexed CD-SSBs scattered within each SSB burst, where each CD-SSB is transmitted on a respective wide beam associated with a beam index. In one example, a UE may identify the strongest wide beam based on SSB measurements and choose a physical random access channel (PRACH) preamble associated with the SSB index for initial access. Additionally, network (e.g., gNB or satellite) may configure transmission configuration indication (TCI) states with tci-stateId (e.g., of value 0 to 11), where each TCI state may include beam/servingCellIndex (e.g., of value 0 to 31) and BWP ID (e.g. of value 0 to 4), quasi co-location (QCL) type (e.g., of value type-A, type-B, type-C, or type-D), SSB index (e.g., of value 0 to 63), and channel state information-reference signal (CSI-RS) resource ID (e.g., of value 0 to 191). If more than one TCI state is configured, a downlink control information (DCI) or a medium access control (MAC) control element (CE) may be used as an activation command to activate certain configured TCI state(s).

Under the first proposed scheme in accordance with the present disclosure, mechanisms of enhanced beam configuration for initial access are provided in which the network may configure the wide beam(s) to be always ON for initial access, cell re-selection, and/or idle-mode mobility, where each wide beam may be associated with a CD-SSB. This may ensure backward compatibility for legacy UEs to perform DL synchronization, acquire system information, and perform initial access procedure. There may be a single wide beam or several wide beams per satellite, depending on different satellite beam configurations. Additionally, there may be up to K narrow beams QCL'ed with the wide beam(s) (e.g. type-A QCL assuming wide beam and narrow beam overlapping geographically), where each narrow beam may be associated with an NCD-SSB or a CSI-RS. Once synchronized to the cell on the DL direction, the UE would know the satellite cell ID.

In some implementations, each narrow beam may have an associated tci-stateId with a CD-SSB or CSI-RS (i.e., each narrow beam is associated with a TCI state including QCL information with a CD-SSB or CSI-RS) if BWP#0 overlaps with active BWP#1, BWP#2, or BWP#3. Alternatively, each narrow beam may have an associated tci-stateId with an NCD-SSB or CSI-RS if BWP#0 does not overlap with active BWP#1, BWP#2, or BWP#3.

In some implementations, the ON/OFF periods of the narrow beams may be aligned with the periodicity patterns of the NCD-SSB or CSI-RS. That is, each narrow beam may be configured to be ON or OFF based on the periodicity pattern of the NCD-SSB or the CSI-RS. On the other hand, the UE does not need to know the ON/OFF periods of the narrow beams since network can properly handle the scheduling of when the narrow beams are ON/OFF.

In some implementations, the periodicity pattern of NCD-SSB or CSI-RS may be configured via radio resource control (RRC) signaling.

Under the second proposed scheme in accordance with the present disclosure, mechanisms of beams ON/OFF setting for initial access are provided in which the network may configure the wide beam(s) to be ON when the UE expects the CD-SSB for DL synchronization, SI (at least SIB1) acquisition, and initial access. Specifically, the UE may synchronize to the coarse beam (i.e., synchronize to the cell) using the CD-SSB, and select when to transmit a PRACH preamble (also called the random access request or message-1 (Msg1)) on one narrow beam (which may be determined from the UE's position, or determined from measurements on time domain multiplexed NCD-SSB between narrow beams or CSI-RS). The PRACH preamble is associated with a narrow beam index. The NCD-SSB may also be used for better timing tracking, and the UE does not need to switch to the wide beam to measure the CSI-RS for fine timing tracking. The message-2 (Msg2) (i.e., random access response (RAR)) and message-4 (Msg4) (i.e., message for contention resolution) of the random access (RA) procedure may be received on the narrow beams or on the wide beam. For wide beam, the CD-SSB periodicity for DL synchronization and initial cell search may be at least 20 milliseconds (ms).

In some implementations, the periodicities of NCD-SSB or CSI-RS on narrow beams may be much larger (e.g. 160 ms). These NCD-SSBs or CSI-RSs may be used for DL synchronization and/or radio link monitoring (RLM)/radio resource management (RRM) for beam management.

In some implementations, narrow beams may be configured to be ON for certain time periods to ensure that the PRACH preamble transmitted on that beam is received, to ensure that RAR is transmitted in the RAR window (e.g., less than 10 ms in licensed spectrum, or less than 40 ms in un-licensed spectrum), and/or to ensure Msg3 reception and to transmit Msg4 during the contention resolution window (e.g., 8 to 64 ms).

In some implementations, for scheduling data, there are no restrictions on when a narrow beam needs to be ON or OFF and this may be left to network (e.g., gNB or satellite) scheduler implementation. For example, network may not schedule DL or uplink (UL) grants for the UE when the narrow beams are OFF.

Under the third proposed scheme in accordance with the present disclosure, mechanisms of narrow beam determination based on PRACH preamble sent on wide beam are provided in which the UE may transmit the PRACH preamble on the wide beam and network may determine a narrow beam based on the direction or the angle of arrival (AoA) of the received PRACH preamble.

In some implementations, the network may switch legacy (e.g., release 17/18 (R17/18)) UEs or R19 UEs to narrow beams at any point thereafter (during or after initial access). In one example, the legacy beam switching mechanisms may be reused.

In some implementations, the network may turn narrow beams OFF for the time period of RLM (e.g., 160 ms) without impacting the legacy R17/R18 connected UEs or R19 connected UEs.

In some implementations, the network may increase/prolong the ON duration of narrow beams based on UE's traffic (e.g., traffic demand, and/or traffic QoS, etc.).

Under the fourth proposed scheme in accordance with the present disclosure, mechanisms of narrow beam determination based on narrow beam sweeping are provided in which the UE may select a PRACH resource associated with a narrow beam, an NCD-SSB index, or a CSI-RS resource ID. There is no need to have the narrow beams ON for a minimum time duration or duty cycles because there can be PRACH preambles/occasions associated with a narrow beam via common RRC configuration. Specifically, after DL synchronization and SIB1 acquisition on wide beam, the UE may receive some additional assistance information via system information (e.g. SIB19), which may include at least one of the following: (i) index or indices of the narrow beam(s); (ii) reference point(s) or distance threshold(s) to the narrow beam(s); (iii) offset(s) of differential power gain on the wide beam or the narrow beam(s); and (iv) PRACH resource(s) (e.g., represented by time and frequency domain location(s)) or PRACH preamble set(s) associated with the narrow beam(s). The UE may use the assistance information to select an appropriate narrow beam, e.g., based on the UE's location. Then, the UE may select a PRACH preamble/resource associated with the narrow beam to trigger initial access on the narrow beam, complete the initial access on the narrow beam, and receive UE-specific RRC configuration applicable to the narrow beam for data transmission.

In some implementations, the network may increase/prolong the ON duration of narrow beams based on UE's traffic (e.g., traffic demand, and/or traffic QoS, etc.).

### Illustrative Implementations

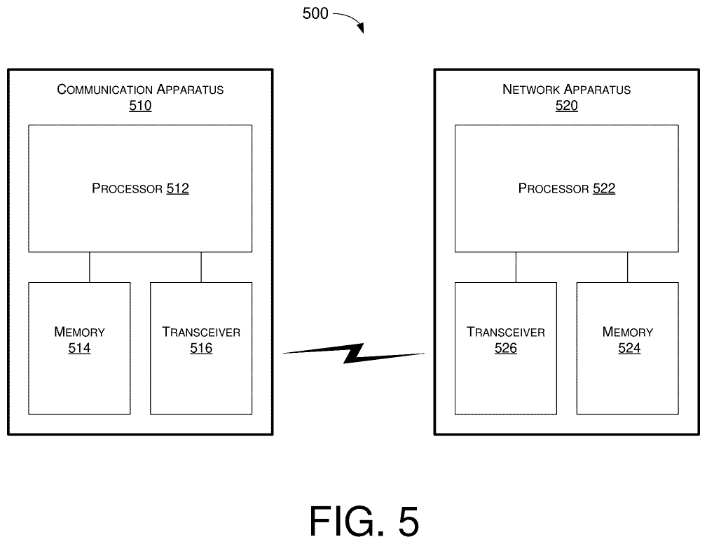

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to initial access with enhanced beam configuration in wireless communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 510 may also be a part of a machine type apparatus, which may be an IoT, NB-IoT, IIoT, BL, or CE UE such as an immobile or a stationary apparatus, a home apparatus, a roadside unit (RSU), a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of an electronic apparatus, which may be a network node such as a satellite, a base station (BS), a small cell, a router or a gateway of an NTN. For instance, network apparatus 520 may be implemented in a satellite or an eNB/gNB/TRP in a 4G/5G, NR, IoT, NB-IoT or IIoT network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks, including initial access with enhanced beam configuration in wireless communications, in a device (e.g., as represented by communication apparatus 510) and a network node (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In some implementations, transceiver 516 may be capable of wirelessly communicating with different types of UEs and/or wireless networks of different radio access technologies (RATs). In some implementations, transceiver 516 may be equipped with a plurality of antenna ports (not shown) such as, for example, four antenna ports. That is, transceiver 516 may be equipped with multiple transmit antennas and multiple receive antennas for beamforming and multiple-input multiple-output (MIMO) wireless communications. In some implementations, network apparatus 520 may also include a transceiver 526 coupled to processor 522. Transceiver 526 may include a transceiver capable of wirelessly transmitting and receiving data. In some implementations, transceiver 526 may be capable of wirelessly communicating with different types of UEs of different RATs. In some implementations, transceiver 526 may be equipped with a plurality of antenna ports (not shown) such as, for example, four antenna ports. That is, transceiver 526 may be equipped with multiple transmit antennas and multiple receive antennas for beamforming and MIMO wireless communications.

In some implementations, communication apparatus 510 may further include a memory 514 coupled to processor 512 and capable of being accessed by processor 512 and storing data therein. In some implementations, network apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 510 and network apparatus 520 may be a communication entity capable of communicating with each other using various proposed schemes in accordance with the present disclosure. For illustrative purposes and without limitation, a description of capabilities of communication apparatus 510, as a UE, and network apparatus 520, as a network node (e.g., a satellite or BS), is provided below with processes 600 and 700.

### Illustrative Processes

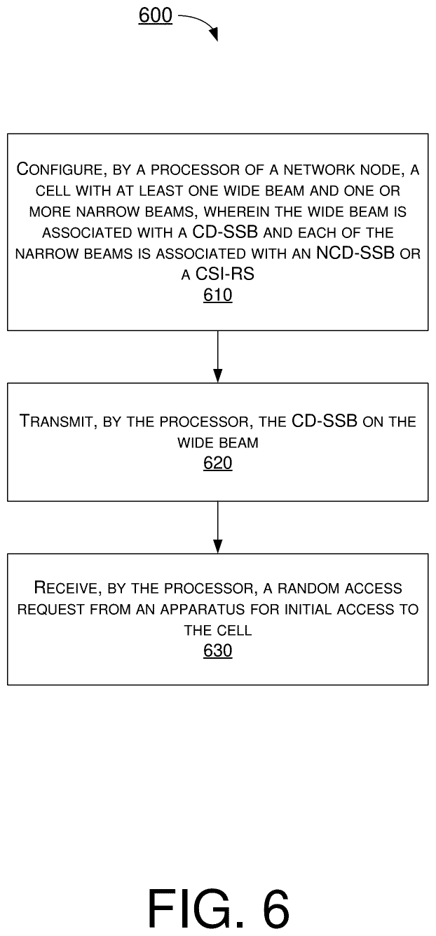

FIG. 6 illustrates an example process 600 in accordance with an implementation of the present disclosure. Process 600 may be an example implementation of above scenarios/schemes, whether partially or completely, with respect to initial access with enhanced beam configuration in wireless communications. Process 600 may represent an aspect of implementation of features of network apparatus 520. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by or in network apparatus 520 as well as any variations thereof. Solely for illustrative purposes and without limitation, process 600 is described below in the context of communication apparatus 510, as a UE, and network apparatus 520, as a network node (e.g., a satellite or BS). Process 600 may begin at block 610.

At 610, process 600 may involve processor 522 of network apparatus 520 configuring a cell with at least one wide beam and one or more narrow beams, wherein the wide beam is associated with a CD-SSB and each of the narrow beams is associated with an NCD-SSB or a CSI-RS. Process 600 may proceed from block 610 to block 620.

At 620, process 600 may involve processor 522 transmitting, via transceiver 526, the CD-SSB on the wide beam. Process 600 may proceed from block 620 to block 630.

At 630, process 600 may involve processor 522 receiving, via transceiver 526, a random access request from communication apparatus 510 for initial access to the cell.

In some implementations, the wide beam may be configured to be always activated for the transmission of the CD-SSB, and each of the narrow beams is configurable to be activated or deactivated for data transmission.

In some implementations, the narrow beams may be quasi co-located (QCL'ed) with the wide beam.

In some implementations, each of the narrow beams may be associated with a TCI state comprising QCL information with the CD-SSB or the CSI-RS in an event that an initial BWP overlaps with an active BWP or may be associated with a TCI state comprising QCL information with the NCD-SSB or the CSI-RS in an event that an initial BWP does not overlap with an active BWP.

In some implementations, each of the narrow beams may be configured to be activated or deactivated based on a periodicity pattern of the NCD-SSB or the CSI-RS.

In some implementations, the periodicity pattern of the NCD-SSB or the CSI-RS may be configured via an RRC signaling.

In some implementations, process 600 may further involve processor 522 activating, via transceiver 526, the narrow beams for a first time period to receive the random access request from communication apparatus 510, to transmit a random access response to communication apparatus 510, or to receive a scheduled transmission from communication apparatus 510 and transmit a message for contention resolution to communication apparatus 510. Alternatively, process 600 may further involve processor 522 deactivating, via transceiver 526, deactivating, by the processor, the narrow beams for a second time period of RLM.

In some implementations, process 600 may further involve processor 522 determining not to schedule a DL or UL grant for communication apparatus 510 in an event that the narrow beams are deactivated.

In some implementations, process 600 may further involve processor 522 determining one of the narrow beams based on a direction or an AoA of the random access request.

In some implementations, process 600 may further involve processor 522 activating the narrow beams for a time period for data transmission, and prolonging the time period based on traffic of communication apparatus 510.

In some implementations, process 600 may further involve processor 522 transmitting, via transceiver 526, assistance information to communication apparatus 510. Specifically, the assistance information may include at least one of the following: (i) one or more indices of the narrow beams; (ii) one or more reference points or distance thresholds to the narrow beams; (iii) one or more offsets of differential power gain on the wide beam or the narrow beams; and (iv) one or more PRACH resources or PRACH preamble sets associated with the narrow beams.

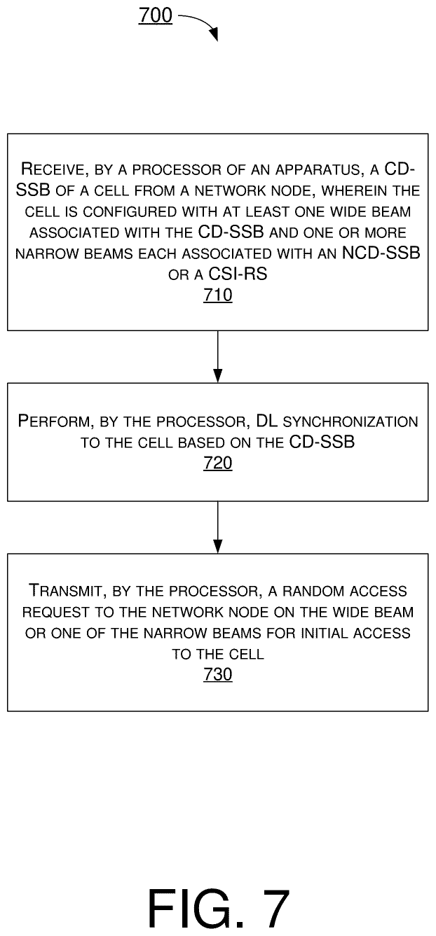

FIG. 7 illustrates an example process 700 in accordance with an implementation of the present disclosure. Process 700 may be an example implementation of above scenarios/schemes, whether partially or completely, with respect to initial access with enhanced beam configuration in wireless communications. Process 700 may represent an aspect of implementation of features of communication apparatus 510. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by or in communication apparatus 510 as well as any variations thereof. Solely for illustrative purposes and without limitation, process 700 is described below in the context of communication apparatus 510, as a UE, and network apparatus 520, as a network node (e.g., a satellite or BS). Process 700 may begin at block 710.

At 710, process 700 may involve processor 512 of communication apparatus 510 receiving, via transceiver 516, a CD-SSB of a cell from network apparatus 520, wherein the cell is configured with at least one wide beam associated with the CD-SSB and one or more narrow beams each associated with an NCD-SSB or a CSI-RS. Process 700 may proceed from block 710 to block 720.

At 720, process 700 may involve processor 512 performing DL synchronization to the cell based on the CD-SSB. Process 700 may proceed from block 720 to block 730.

At 730, process 700 may involve processor 512 transmitting, via transceiver 516, a random access request to network apparatus 520 on the wide beam or one of the narrow beams for initial access to the cell.

In some implementations, the wide beam may be configured to be always activated for the transmission of the CD-SSB, and each of the narrow beams may be configurable to be activated or deactivated for data transmission.

In some implementations, the narrow beams may be quasi co-located (QCL'ed) with the wide beam.

In some implementations, each of the narrow beams may be associated with a TCI state comprising QCL information with the CD-SSB or the CSI-RS in an event that an initial BWP overlaps with an active BWP or may be associated with a TCI state comprising QCL information with the NCD-SSB or the CSI-RS in an event that an initial BWP does not overlap with an active BWP.

In some implementations, each of the narrow beams may be configured to be activated or deactivated based on a periodicity pattern of the NCD-SSB or the CSI-RS.

In some implementations, the periodicity pattern of the NCD-SSB or the CSI-RS may be configured via an RRC signaling.

In some implementations, process 700 may further involve processor 512 selecting a PRACH resource associated with the one of the narrow beams for the transmission of the random access request.

In some implementations, process 700 may further involve processor 512 receiving, via transceiver 516, assistance information from network apparatus 520, and selecting the one of the narrow beams for the transmission of the random access request based on the assistance information.

In some implementations, the assistance information may include at least one of the following: (i) one or more indices of the narrow beams; (ii) one or more reference points or distance thresholds to the narrow beams; (iii) one or more offsets of differential power gain on the wide beam or the narrow beams; and (iv) one or more PRACH resources or PRACH preamble sets associated with the narrow beams.

In some implementations, the assistance information may be received via system information (e.g., SIB19).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
configuring, by a processor of a network node, a cell with at least one wide beam and one or more narrow beams, wherein the wide beam is associated with a cell-defining synchronization signal block (CD-SSB) and each of the narrow beams is associated with a non-cell-defining synchronization signal block (NCD-SSB) or a channel state information-reference signal (CSI-RS);
transmitting, by the processor, the CD-SSB on the wide beam; and
receiving, by the processor, a random access request from an apparatus for initial access to the cell.

2. The method of claim 1, wherein the wide beam is configured to be always activated for the transmission of the CD-SSB, and each of the narrow beams is configurable to be activated or deactivated for data transmission.

3. The method of claim 1, wherein the narrow beams are quasi co-located with the wide beam.

4. The method of claim 3, wherein each of the narrow beams is associated with a transmission configuration indication (TCI) state comprising quasi co-location (QCL) information with the CD-SSB or the CSI-RS in an event that an initial bandwidth part (BWP) overlaps with an active BWP or is associated with a TCI state comprising QCL information with the NCD-SSB or the CSI-RS in an event that an initial BWP does not overlap with an active BWP.

5. The method of claim 1, wherein each of the narrow beams is configured to be activated or deactivated based on a periodicity pattern of the NCD-SSB or the CSI-RS, and the periodicity pattern of the NCD-SSB or the CSI-RS is configured via a radio resource control (RRC) signaling.

6. The method of claim 1, further comprising:
activating, by the processor, the narrow beams for a first time period to receive the random access request from the apparatus, to transmit a random access response to the apparatus, or to receive a scheduled transmission from the apparatus and transmit a message for contention resolution to the apparatus; or
deactivating, by the processor, the narrow beams for a second time period of radio link monitoring (RLM).

7. The method of claim 1, further comprising:
determining, by the processor, not to schedule a downlink (DL) or uplink (UL) grant for the apparatus in an event that the narrow beams are deactivated.

8. The method of claim 1, further comprising:
determining, by the processor, one of the narrow beams based on a direction or an angle-of-arrival (AoA) of the random access request.

9. The method of claim 1, further comprising:
activating, by the processor, the narrow beams for a time period for data transmission; and
prolonging, by the processor, the time period based on traffic of the apparatus.

10. The method of claim 1, further comprising:
transmitting, by the processor, assistance information to the apparatus, wherein the assistance information comprises at least one of the following:
one or more indices of the narrow beams;
one or more reference points or distance thresholds to the narrow beams;
one or more offsets of differential power gain on the wide beam or the narrow beams; and
one or more physical random access channel (PRACH) resources or PRACH preamble sets associated with the narrow beams.

11. A method, comprising:
receiving, by a processor of an apparatus, a cell-defining synchronization signal block (CD-SSB) of a cell from a network node, wherein the cell is configured with at least one wide beam associated with the CD-SSB and one or more narrow beams each associated with a non-cell-defining synchronization signal block (NCD-SSB) or a channel state information-reference signal (CSI-RS);
performing, by the processor, downlink (DL) synchronization to the cell based on the CD-SSB; and
transmitting, by the processor, a random access request to the network node on the wide beam or one of the narrow beams for initial access to the cell.

12. The method of claim 11, wherein the wide beam is configured to be always activated for the transmission of the CD-SSB, and each of the narrow beams is configurable to be activated or deactivated for data transmission.

13. The method of claim 11, wherein the narrow beams are quasi co-located with the wide beam.

14. The method of claim 13, wherein each of the narrow beams is associated with a transmission configuration indication (TCI) state comprising quasi co-location (QCL) information with the CD-SSB or the CSI-RS in an event that an initial bandwidth part (BWP) overlaps with an active BWP or is associated with a TCI state comprising QCL information with the NCD-SSB or the CSI-RS in an event that an initial BWP does not overlap with an active BWP.

15. The method of claim 11, wherein each of the narrow beams is configured to be activated or deactivated based on a periodicity pattern of the NCD-SSB or the CSI-RS.

16. The method of claim 15, wherein the periodicity pattern of the NCD-SSB or the CSI-RS is configured via a radio resource control (RRC) signaling.

17. The method of claim 11, further comprising:
selecting, by the processor, a physical random access channel (PRACH) resource associated with the one of the narrow beams for the transmission of the random access request.

18. The method of claim 11, further comprising:
receiving, by the processor, assistance information from the network node; and
selecting, by the processor, the one of the narrow beams for the transmission of the random access request based on the assistance information.

19. The method of claim 18, wherein the assistance information comprises at least one of the following:
one or more indices of the narrow beams;
one or more reference points or distance thresholds to the narrow beams;
one or more offsets of differential power gain on the wide beam or the narrow beams; and
one or more physical random access channel (PRACH) resources or PRACH preamble sets associated with the narrow beams.

20. The method of claim 18, wherein the assistance information is received via system information.
